(19) United States
(12) Patent Application Publication
(10) Pub. No.: US 2006/0240167 A1
(43) Pub. Date: Oct. 26, 2006

(54) Ultrafine ground tea dispersion and food or beverage containing the same

(76) Inventors: Kenzo Takahashi, Osaka (JP); Yoshihito Suda, Tokyo (JP); Daisuke Yamada, Kyoto (JP); Kentaro Oie, Osaka (JP)

Correspondence Address: DRINKER BIDDLE & REATH (DC), 1500 K STREET, N.W., SUITE 1100, WASHINGTON, DC, 20005-1209, US

(21) Appl. No.: 10/560,936

(22) PCT Filed: Jun. 15, 2004
(86) PCT No.: PCT/JP04/08349

§ 371 Date: May 16, 2006

(30) Foreign Application Priority Data
Jun. 16, 2003 (JP) 2003-171333

(51) Int. Cl. A23F 3/00

(52) U.S. Cl. 426/597

(57) ABSTRACT

An ultrafine ground tea dispersion characterized by being produced by grinding a tea raw material, obtaining a powdered tea from the ground product, subjecting the obtained powdered tea to further fine grinding and removing most of the particles of 1 μm or more in diameter. The tea beverage produced by blending the ultrafine ground tea dispersion is high quality exhibiting minimized roughness and miscellaneous taste, retaining refreshing aftertaste indispensable for green tea beverage, having the original texture, body and flavor of green tea and being stable so as to be free from precipitation or turbidity even if stored for a prolonged period of time.

### TECHNICAL FIELD

The present invention relates to an ultrafine ground tea dispersion characterized by being produced by grinding a tea raw material, subjecting the obtained powdered tea to further ultrafine grinding, and removing most of the particles of 1 μM or more in diameter; a food or beverage containing the same; and a method for the production thereof.

### BACKGROUND ART

Green tea beverages have been popular with a broad range of people because they have a good distinctive flavor and high palatability, and also they go well with food, combined with a growing awareness of health issues among people. Green tea beverages are a typical sugarfree, low calorie beverage. Among them, in particular, green tea beverages in a pet bottle having excellent portability and an advantage of being capable of recapped have matched consumer's needs, and their market scale has been quickly expanded. On the other hand, since transparent containers such as PET bottles and bottles have a container property of transparency, a number of various production technologies for inhibiting turbidity and precipitation have been developed and carried out so far, taking consideration of possible quality problems caused by residual tea leaves and turbidity thought to be derived from eluted components from tea leaves.

However, there were problems that original flavor components of green tea have been also removed in the production steps, and original good flavor and body of green tea were spoiled. In order to solve these problems, it is possible to give an original texture of green tea by directly adding ground tea leaves obtained through dry pulverization, or adding the suspension thereof. However, since the size of the particles obtained by dry pulverization is about 10 μm, such particles have texture with roughness, and refreshing feeling and refreshing aftertaste required for green tea beverages are spoiled in them, giving often undesirable results. Although particles can be made more fine by wet pulverization, sufficient refreshing feeling could not be obtained, and there was a fear of precipitation which would occur with the lapse of time (see JP-A-8-116881).

Further, although there is disclosed a method producing extraction of teal leaves, which comprises dispersing and suspending tea leaves in water as fine particles to form a slurry, and then separating and removing such fine particles of tea leaves from the slurry (see JP-A-3-108444), no satisfaction was obtained in respect of flavor and texture.

Furthermore, as a method for producing an insoluble solid material-containing beverage which does not generate the precipitation and turbidity due to the insoluble solid material having excellent dispersion such as cocoa, coffee, Matcha (powdered green tea), etc., it is known that JP-A-2001-29053 discloses a method which comprises adding a powdery or paste-like solid insoluble material and a stabilizer (e.g. carrageenan, gellan gum, etc.) to water or hot water, and homogenizing the mixture. However, in this method, there was a fear that the stabilizer affects physical properties such as flavor and viscosity of such beverages.

Although it is known that a green tea beverage is obtained by extracting a green tea, removing the particles from the extract so as to keep the turbidity (OD720) to not more than 0.05, and adding the obtained powdered green tea, there is a fear that the refreshing feeling is lost and precipitation is formed, depending on the diameter of particles of the powdered green tea to be added (see JP-A-8-163958).

### DISCLOSURE OF THE INVENTION

An object of the present invention is to develop a stable beverage, especially a green tea beverage, exhibiting minimized roughness and miscellaneous taste, retaining refreshing aftertaste indispensable for green tea beverage, having its original texture, body and flavor of green tea and being stable so as to be free from precipitation or turbidity even if stored for a long period of time.

The inventors of the present invention have studied on the above problem and found that such problem can be solved by a beverage which is obtained by adding an ultrafine ground tea dispersion produced through grinding of a tea raw material, further fine grinding of the obtained powdered tea and removal of most of particles of 1 μm or more in diameter, or a fine powdered tea produced through grinding of a tea raw material and further fine grinding of the obtained powdered tea, to a beverage, and removing the particles of 1 μm or more in diameter. Further, as a result of investigation by the inventors of the present invention so as to find preferable embodiments, they have succeeded in producing a tea beverage having the original body and sweetness of green teas, said tea beverage being produced by grinding a tea raw material, suspending the obtained powdered tea in water, subjecting the suspension to further fine grinding treatment through wet pulverization using a high pressure-homogenizer so that the ratio of particles of 1 μm or less in diameter is increased, removing most of unnecessary particles of 1 μm or more in diameter, admixing it with a conventional green tea extract which was filtered, so as to adjust the turbidity to be 0.05 or more, or adding an ultrafine ground tea to a conventional green tea beverage and removing most of the particles of 1 μm or more in diameter from the beverage to adjust the turbidity to be 0.05 or more. In the above step, it becomes possible to suppress occurrence of precipitation by removing most of the particles of 1 μm or more in diameter by centrifugation and maintaining the turbidity at 0.15 or less after mixing and dilution with a conventional green tea extract.

Namely, the present invention relates to:
(1) an ultrafine ground tea dispersion characterized by being produced by grinding a tea raw material, subjecting the obtained powdered tea to further fine grinding, and removing most of the particles of 1 μm or more in diameter,
(2) a food or beverage, wherein the ultrafine ground tea dispersion according to the above (1) is blended,
(3) a beverage characterized by being produced by grinding a tea raw material, subjecting the obtained powdered tea to further fine grinding, blending the tea with a beverage, and removing most of the particles of 1 μm or more in diameter,
(4) a tea beverage characterized by being produced by grinding a tea raw material, subjecting the obtained powdered tea to further fine grinding, blending the tea with a tea extract, and removing most of the particles of 1 μm or more in diameter,
(5) a method for producing an ultrafine ground tea dispersion, which comprises grinding a tea raw material, subjecting the obtained powdered tea to ultrafine grinding, and removing most of the particles of 1 μm or more in diameter,
(6) a method for producing an ultrafine ground tea dispersion, which comprises grinding a tea raw material, subjecting the obtained powdered tea to fine grinding with the use of a high pressure homogenizer, and removing most of the particles of 1 μm or more in diameter,
(7) the method for producing an ultrafine ground tea dispersion according to the above (5) or (6), wherein most of particles of 1 μm or more in diameter are removed by means of centrifugation,
(8) a method for producing a food or beverage, which comprises blending the ultrafine ground tea dispersion according to the above (1) with a food or beverage,
(9) a method for producing a beverage, which comprises grinding a tea raw material, subjecting the obtained powdered tea to further fine grinding, blending the tea with a beverage, and removing most of the particles of 1 μm or more in diameter,
(10) a method for producing a tea beverage, which comprises grinding a tea raw material, subjecting the obtained powdered tea to further fine grinding, blending the tea with a tea extract, and removing most of the particles of 1 μm or more in diameter,
(11) a method for producing a tea beverage, which comprises blending the ultrafine ground tea dispersion according to the above (1) with a tea extract,
(12) a tea beverage produced by the method according to the above (11), and
(13) the tea beverage according to the above (12), which has a turbidity (absorbance at 680 nm) of 0.05 to 0.15.

### EFFECT OF THE INVENTION

The beverage of the present invention is a beverage of high quality exhibiting minimized roughness and miscellaneous taste, retaining refreshing aftertaste indispensable for tea beverages (for example, green tea beverages), having the original texture, body and flavor of teas (for example, green tea) and being stable so as to be free from precipitation or turbidity even if stored for a prolonged period of time.

### BRIEF EXPLANATION OF THE DRAWINGS

FIG. 1 shows production steps for ultrafine ground tea dispersion.

FIG. 2 shows particle size distribution of ultrafine ground tea dispersion.

### BEST MODE FOR CARRYING OUT THE INVENTION

The ultrafine ground tea dispersion of the present invention can be produced by (a) grinding a tea raw material (grinding step), (b) subjecting the obtained powdered tea to further fine grinding (ultrafine grinding step), and (c) removing most of the particles of 1 μm or more in diameter (removal step of coarse particles).

Also, a food or beverage utilizing the ultrafine ground tea dispersion of the present invention can be produced by (a) grinding a tea raw material (grinding step), (b) subjecting the obtained powdered tea to further fine grinding (ultrafine grinding step), (c) removing most of the particles of 1 μm or more in diameter (removal step of coarse particles), and (d) blending the obtained ultrafine ground tea dispersion with a food or beverage (blending step). Alternatively, such food or beverage can be produced without subjecting the treated ultrafine ground tea product obtained through the steps of (a) to (c), to the step of (d).

Hereinafter, each of the above steps is described.

(a) Grinding Step

The tea raw material which can be used in the present invention includes, for example, though it is not limited, fermented tea, semi-fermented tea and non-fermented tea. Specifically, there are exemplified tea leaves of green tea belonging to Camellia Sinensis, oolong tea, black tea, powdered tea, roasted tea or the like.

There is no particular limitation on the grinding method for the tea raw material, and a conventional grinding method including dry pulverization and wet pulverization can be employed. For example, there can be used pulverization apparatus such as stone mortar, pin mill, hammer mill, cutter mill, colloid mill, axial flow type mill, homogenizer, and the like. By this grinding step, the tea raw material is preferably ground to generally a particle size of about 1 to 100 μm. Like this, a powdered tea (hereinafter, also referred to as fine ground tea) can be obtained.

(b) Ultrafine Grinding Step

In the further fine grinding (ultrafine grinding) of the powdered tea obtained in the above step (a), apparatus and a method used are not particularly limited so long as they can grind the powdered tea to convert the particle size into a size of about 1 μm or less in diameter, and a conventional apparatus and method can be used. For example, fluid type mill, medium type mill, grinding type mill, planetary ball mill, vibration ball mill, ultrasonic ball mill, colloid mill, high pressure homogenizer, or the like can be used. It is preferable to use wet pulverization using a high pressure homogenizer. The high pressure homogenizer means an apparatus which makes an emulsion drop or a suspension particle into ultrafine particles by shear or cabitation or the like generated, for example, through jetting a liquid from fine space under a high pressure. If required, liquid is added at this ultrafine grinding step. For example, water is added to a powdered tea, and appropriate operation and ultrafine grinding may be carried out preferably in the presence of water so that the ratio of the powdered tea of 1 μm or less in diameter becomes increased. In the case of using water, although there is no particular limitation on the amount of the ground tea product and water, the amount of water to be mixed with the ground tea product is usually about 5 to 50 parts by weight, preferably about 10 to 30 parts by weight, to one part by weight of the ground tea product. Other than water, a liquid such as tea extract may be used. The tea extract includes, for example, an extract of tea leaves with hot water, a hot water extract of tea leaves to which sodium hydrogen carbonate and L-ascorbic acid are added, and a conventional tea, and the like.

However, in the ultrafine grinding with the use of a high pressure homogenizer, water is added to the powdered tea obtained in the step of (a), and then this step (b) is usually performed in a suspended state in the presence of water. Although it cannot be generally mentioned because the operation conditions of high-pressure homogenizer is different depending on the models, it is preferable to operate the homogenizer at a pressure of 100 kg/cm or more.

(C) Removal Step of Coarse Particles

The fine powdered tea obtained in the step of (b) may be a solid form or a suspension, wherein the tea having a particle of about 1 μm or less in diameter is increased compared to the tea prior to the step of (b). In the case where the finely powdered tea is solid, water is added as in the above step of (b) to give a suspension, and the suspension is subjected to this step of (c). Also, a beverage or a tea extract may be added to the finely powdered tea obtained in the above step of (b), and the obtained suspension may be subjected to this step of (c). The beverage includes various beverages such as tea beverage, alcohol beverage, coffee beverage, juice, fruit juice, carbonic acid beverage, and the like.

In the present step (c) of removing coarse particles, it is an object to remove most of particles of 1 μm or more in diameter. The above “most of” means usually about “not less than 50%”, preferably about “not less than 95%”, more preferably about “not less than 99%”. Although there is no particular limitation on the method for removing coarse particles so long as it can remove coarse particles of 1 μm or more in diameter, most of coarse particles having 1 μm or more in diameter can be removed generally by centrifuge, thereby to give a desired ultrafine ground tea dispersion. The turbidity of the thus obtained ultrafine ground tea dispersion is about 0.05 to 1.5 as measured in terms of absorbance at 680 nm.

(d) Blending Step

The ultrafine ground tea dispersion obtained in the above step (c) may be blended with a food or beverage, thereby to provide a food or beverage containing an ultrafine ground tea.

For example, although the ultrafine ground tea dispersion may be diluted with water as it is, into a tea beverage, it is preferable to blend the ultrafine ground tea dispersion with a tea beverage, thereby giving a tea beverage with improved flavor. Further, after blending the ultrafine ground tea dispersion, most of particles of 1 μm or more in diameter may be removed. The term “most of” has the same meaning as defined above. In the case where the tea leaves used in the step of (a) is green tea leaves, the ultrafine ground tea dispersion is blended with a conventional green tea extract, i.e. conventional tea, to produce a green tea beverage with improved flavor. The conventional tea can be obtained by extracting a green tea with a hot water of about 60° C. to 90° C. for about 2 to 10 minutes, filtering the extract, adding L-ascorbic acid and sodium hydrogen carbonate thereto, and sterilizing and filling the solution. The turbidity of the conventional tea as measured in terms of absorbance at 680 nm is approximately not more than 0.030. The obtained green tea beverage is high quality exhibiting minimized roughness and miscellaneous taste, retaining refreshing aftertaste indispensable for green tea beverage, having the original texture, body and flavor of a green tea and being stable so as to be free from precipitation or turbidity even if stored for a prolonged period of time. Even if this green tea beverage is filled in a transparent container represented by a PET bottle and stored for a long period of time, it is an excellent beverage which is free from problem on appearance, such as precipitation or turbidity caused by the lapse of time.

In the production of green tea beverages, the blending ratio between the ultrafine ground tea dispersion of the present invention and the green tea extract is generally about 1:1-10 (by weight), preferably 1:2-8 (by weight).

Besides the above, the ultrafine ground tea dispersion of the present invention may be blended with Japanese sweets such as Yo-kan (sweet jelly made from bean jam), Uirou (sweet rice jelly), Manjyuu (bean-jam bun), Monaka (bean jam-filled wafer), Andango (skewered dumpling with bean jam), etc.; Western cakes such as cake, sponge cake, cream puff, gelly, mousse, etc.; foods such as bread, candy, chocolate, parfait, ice cream, shaved ice, etc.; or beverages such as soft drink, sports drink, health drink, etc. Although the blending ratio may vary properly depending on the kind of food or beverage, and the targeted flavor, etc., it is generally about 5 to 50% (w/w), preferably about 10 to 30% (w/w) to raw material of such a food or beverage. Moreover, in the production of desired food or beverage, conventional components such as sugars, minerals, vitamins, and the like may be blended according to the necessity.

Further, when a beverage or a tea extract, etc. is added to the finely ground powder tea and the obtained suspension is subjected to the above step (c), the ultrafine ground tea product obtained through the steps of (a) to (c) may be served as a beverage or a tea beverage as it is without subjecting to the above step of (d). More specifically, for example, the finely ground powder tea (e.g. powder, suspension, etc.) obtained through the above steps of (a) and (b) is added to a beverage or a tea extract; most of particles of 1 μm or more in diameter are removed; L-ascorbic acid and sodium hydrogen carbonate are added thereto to adjust to the appropriate concentration; and then the solution was sterilized and filled. The blending ratio of the finely ground tea and a beverage or a tea extract is generally about 1:1-10 (by weight), preferably 1:2-8 (by weight).

### EXAMPLES

Hereinafter, the present invention will be described in more detail by way of Examples, but it is to be construed that the present invention is not limited by these Examples.

### Example 1

Production of Ultrafine Ground Tea Dispersion

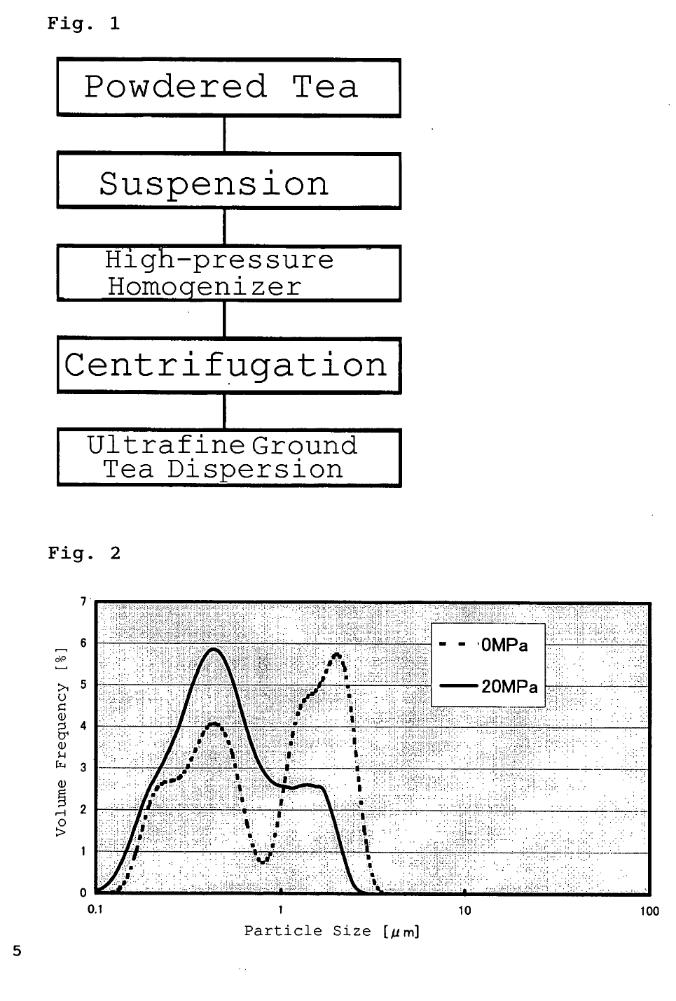

Matcha (powdered green tea) obtained by grinding Tencha (a kind of green tea) with a stone mortar was suspended in about 20-fold amount of water. The suspension was treated with a high pressure homogenizer at a pressure of 15 MPa and centrifuged at 6,000 rpm for 10 minutes to obtain an ultrafine ground tea dispersion. The production steps are shown in FIG. 1.

FIG. 2 shows particle size distribution (measurement method: laser diffraction-scattering analysis; measurement apparatus: LS230 manufacture by Beckman Coulter Ltd.) of the obtained ultrafine ground tea dispersion and a suspension without treatment using a high pressure-homogenizer. The solid line indicates the results in case where the homogenizer treatment was performed, and the dotted line indicates the results in case where the homogenizer treatment was not performed.

### Example 2

Sensory Evaluation of Green Tea Beverage Containing Ultrafine Ground Tea Dispersion

The ultrafine ground tea dispersion obtained in Example 1 was added in 30% by weight to a green tea extract obtained by extraction and filtration according to the conventional method, and L-ascorbic acid and sodium hydrogen carbonate were added thereto as such that a mixed solution having a turbidity of 0.05 to 0.15 was obtained. The solution was canned and subjected to retort sterilization to obtain a canned green tea beverage. The result of tasting of the final product was good as shown in Table 1, indicating that it had texture, body, a sweet taste, no roughness and a refreshing aftertaste.

### Example 3

Powdered tea (Matcha) obtained by grinding Tencha with a stone mortar was suspended in about 20-fold amount of water. The suspension was treated with a high pressure homogenizer at a pressure of 15 MPa to give a ground tea product. The tea product was added in 30% by weight to a green tea (conventional product), and the mixture was centrifuged to remove most of particles of 1 μm or more in diameter, and then L-ascorbic acid and sodium hydrogen carbonate were added thereto as such that a mixed solution having a turbidity of 0.05 to 0.15 was obtained. The solution was canned and subjected to retort sterilization to obtain a canned green tea beverage. The result of tasting of the final product was good as shown in Table 1, indicating that it had texture, body, a sweet taste, no roughness and a refreshing aftertaste.

### Comparative Example 1

The ultrafine ground tea suspension obtained in Example 1 using a high pressure homogenizer was added in 30% by weight to a green tea extract obtained by extraction and filtration according to the conventional method, and L-ascorbic acid and sodium hydrogen carbonate were added thereto. Thereafter, the solution was canned and subjected to retort sterilization to obtain a canned green tea beverage. The result of tasting of the final product is shown in Table 1, which indicates that, although the beverage had texture and body, the flavor was not good for a remaining roughness and lack of refreshing aftertaste.

### Comparative Example 2

The Matcha suspension of Example 1 was centrifuged at 6,000 rpm for 10 minutes without treatment using a high pressure-homogenizer was added in 30% by weight to a green tea extract obtained by extraction and filtration according to the conventional method, and L-ascorbic acid and sodium hydrogen carbonate were added thereto. Thereafter, the solution was canned and subjected to retort sterilization to obtain a canned green tea beverage. The result of tasting of the final product was not good as shown in Table 1, indicating that it was watery and does not have texture and body.

### Comparative Example 3

In a similar manner to Example 2, a mixed solution having a turbidity of not more than 0.05 was prepared, and the solution was canned and subjected to retort sterilization to obtain a canned green tea beverage. The result of tasting of the final product was not very good as shown in Table 1, indicating that, although it had a refreshing aftertaste, it had little sweet taste with almost no texture and body.

### Comparative Example 4

In a similar manner to Example 2, a mixed solution having a turbidity of not less than 0.15 was prepared, canned, and subjected to retort sterilization to obtain a canned green tea beverage. The comprehensive evaluation of tasting of the final product was good as shown in Table 1, indicating that, although it did not have much refreshing aftertaste, it had texture, body and a sweet taste. However, precipitation occurred in the product in long-term storage.

Based on the above results, it was confirmed that flavor advantage was obtained by grinding tea leaves, suspending the obtained powdered tea in water, subjecting the suspension to further ultrafine grinding with the use of a high pressure homogenizer so that the ratio of fine particles of 1 μm or less in diameter is increased, removing most of unnecessary particles of 1 μm or more in diameter, and mixing the obtained solution with a conventional extract of a green tea, thereby giving a turbidity of 0.05 to 0.15.

TABLE 1

| | Sensory Evaluation | | | | |
|---|---|---|---|---|---|
| | Texture/ | Sweet- | Refreshing | | Comprehensive |
| | Body | ness | feeling | Roughness | Evaluation |
| Example 2 | 2.8 | 3.4 | 3.0 | 1.0 | 4.6 |
| Example 3 | 2.8 | 3.5 | 2.9 | 1.1 | 4.6 |
| Comparative | 3.8 | 2.4 | 0.8 | 3.8 | 2.2 |
| Example 1 | | | | | |
| Comparative | 0.6 | 0.8 | 2.8 | 0.0 | 2.4 |
| Example 2 | | | | | |
| Comparative | 1.0 | 1.6 | 3.0 | 0.4 | 2.8 |
| Example 3 | | | | | |
| Comparative | 3.6 | 3.0 | 1.6 | 2.4 | 4.2 |
| Example 4 | | | | | |

The evaluation was carried out by 5 special panelists in sensory evaluation of tea beverages. Evaluation of flavor was performed using 5-grade evaluation: 4 (strongly felt), 3 (felt), 2 (slightly felt), 1 (little felt), and 0 (no felt). Comprehensive evaluation was performed using 5-grade evaluation: 5 (Good), 4 (Not bad), 3 (tolerate), 2 (Not good), and 1 (Bad).

### Example 4

Production of Green Tea Beverage Containing Ultrafine Ground Tea Dispersion

| | | |
|---|---|---|
| Green tea leaves | 4 | g |
| Finely ground tea leaves (Matcha obtained in Example 1) | 1 | g |
| Sodium hydrogen carbonate | 0.3 | g |
| L-ascorbic acid | 0.4 | g |

Green tea leaves (4 g) were extracted with pure water (140 ml) of 80° C. for 10 minutes and filtered, and sodium hydrogen carbonate (0.3 g) and L-ascorbic acid (0.4 g) were added thereto. Then, an ultrafine ground tea dispersion obtained by treating finely ground tea leaves (1 g) in a similar manner to Example 1 was blended thereto to make a total volume of 1,000 ml, and the solution was sterilized and filled.

### Example 5

Production of Green Tea Beverage Containing Ultrafine Ground Tea Dispersion 2

| | | |
|---|---|---|
| Green tea leaves | 4 | g |
| Finely ground tea leaves (Matcha obtained in Example 1) | 1 | g |
| Sodium hydrogen carbonate | 0.3 | g |
| L-ascorbic acid | 0.4 | g |

Finely ground green tea leaves (1 g) were suspended in about 20-fold amount of water, and the suspension was treated with a high pressure-homogenizer at a pressure of 15 MPa to obtain a ground tea product. Green tea leaves (4 g) was extracted with pure water (140 ml) of 80° C. for 10 minutes. To the obtained extract were added the above ground tea product, sodium hydrogen carbonate (0.3 g) and L-ascorbic acid (0.4 g), and the mixture was centrifuged to remove most of particles of 1 μm or more in diameter. Then, water was added thereto to make a total volume of 1,000 ml, and the solution was sterilized and filled.

### Example 6

Production of Oolong Tea Beverage Containing Ultrafine Ground Tea Dispersion

| | | |
|---|---|---|
| Oolong tea leaves | 4 | g |
| Finely ground tea leaves (obtained by treating oolong tea | 1 | g |
| leaves as a raw material in a similar manner to Example 1 for | | |
| producing Matcha) | | |
| Sodium hydrogen carbonate | 0.3 | g |
| L-ascorbic acid | 0.4 | g |

Oolong tea leaves (4 g) were extracted with pure water (140 ml) of 80° C. for 10 minutes and filtered, and sodium hydrogen carbonate (0.3 g) and L-ascorbic acid (0.4 g) were added. Then, an ultrafine ground tea dispersion obtained by treating finely ground tea leaves (1 g) in a similar manner to Example 1 was blended therewith to make a total volume of 1,000 ml, and the solution was sterilized and filled.

### Example 7

Production of Lemon Tea Containing Ultrafine Ground Tea Dispersion

| | | |
|---|---|---|
| Black tea leaves | 4 | g |
| Finely ground tea leaves (obtained by treating black tea leaves | 1 | g |
| as a raw material in a similar manner to Example 1 for | | |
| producing Matcha) | | |
| Special grade of granulated sugar | 50 | g |
| Lemon juice | 1 | g |
| L-ascorbic acid | 0.4 | g |
| Flavor | 1 | g |

Black tea leaves (4 g) were extracted with pure water (140 ml) of 90° C. for 10 minutes and filtered, and special grade of granulated sugar (50 g), lemon juice (1 g), L-ascorbic acid (0.4 g) and flavor (1 g) were added thereto. Then, an ultrafine ground tea dispersion obtained by treating finely ground tea leaves (1 g) in a similar manner to Example 1 was blended therewith to make a total volume of 1,000 ml, and the solution was sterilized and filled.

### INDUSTRIAL APPLICABILITY

As hereinbefore described, an ultrafine ground tea dispersion having excellent characteristics was obtained by grinding tea leaves, suspending the obtained powdered tea in water, subjecting the suspension to further ultrafine grinding with the use of a high pressure homogenizer so that the ratio of fine particles of 1 μm or less in diameter is increased, removing most of unnecessary particles of 1 μm or more in diameter. This product was blended with a conventional tea extract (e.g. green tea extract, etc.) to make a solution having a turbidity of 0.5 to 0.15, thereby to successfully produce a tea beverage having little roughness and little miscellaneous taste, and having its original body as well as sweetness of a tea (e.g. green tea, etc.). A constant desirable texture can be provided by retaining particles of 1 μm or less in diameter.

Based on these findings, it is possible to produce a beverage having texture and body of a green tea brewed in a Japanese teapot, while retaining refreshing aftertaste indispensable for green tea beverages.

1. An ultrafine ground tea dispersion characterized by being produced by grinding a tea raw material, subjecting the obtained powdered tea to further fine grinding, and removing most of the particles of 1 μm or more in diameter.

2. A food or beverage, wherein the ultrafine ground tea dispersion according to claim 1 is blended.

3. A beverage characterized by being produced by grinding a tea raw material, subjecting the obtained powdered tea to further fine grinding, blending the tea with a beverage, and removing most of the particles of 1 μm or more in diameter.

4. A tea beverage characterized by being produced by grinding a tea raw material, subjecting the obtained powdered tea to further fine grinding, blending the tea with a tea extract, and removing most of the particles of 1 μm or more in diameter.

5. A method for producing an ultrafine ground tea dispersion, which comprises grinding a tea raw material, subjecting the obtained powdered tea to ultrafine grinding, and removing most of the particles of 1 μm or more in diameter.

6. A method for producing an ultrafine ground tea dispersion, which comprises grinding a tea raw material, subjecting the obtained powdered tea to fine grinding with the use of a high pressure homogenizer, and removing most of the particles of 1 μm or more in diameter.

7. The method for producing an ultrafine ground tea dispersion according to claim 5, wherein most of the particles of 1 μm or more in diameter are removed by means of centrifugation.

8. A method for producing a food or beverage, which comprises blending the ultrafine ground tea dispersion according to claim 1 with a food or beverage.

9. A method for producing a beverage, which comprises grinding a tea raw material, subjecting the obtained powdered tea to further fine grinding, blending the tea with a beverage, and removing most of the particles of 1 μm or more in diameter.

10. A method for producing a tea beverage, which comprises grinding a tea raw material, subjecting the obtained powdered tea to further fine grinding, blending the tea with a tea extract, and removing most of the particles of 1 μm or more in diameter.

11. A method for producing a tea beverage, which comprises blending the ultrafine ground tea dispersion according to claim 1 with a tea extract.

12. A tea beverage produced by the method according to claim 11.

13. The tea beverage according to claim 12, which has a turbidity (absorbance at 680 nm) of 0.05 to 0.15.
